(19) United States
(12) Patent Application Publication
(10) Pub. No.: US 2013/0154192 A1
(43) Pub. Date: Jun. 20, 2013

(54) SEALING ASSEMBLY

(71) Applicant: Trelleborg Sealing Solutions US, Inc., Fort Wayne, IN (US)

(72) Inventors: Mark C. Sitko, Fort Wayne, IN (US); Larry J. Castleman, Monroeville, IN (US); Colin D. MacQueen, Fort Wayne, IN (US)

(73) Assignee: TRELLEBORG SEALING SOLUTIONS US, INC., Fort Wayne, IN (US)

(21) Appl. No.: 13/715,036

(22) Filed: Dec. 14, 2012

Related U.S. Application Data
(60) Provisional application No. 61/576,150, filed on Dec. 15, 2011.

(51) Int. Cl. F16J 15/16

(52) U.S. Cl. CPC F16J 15/16
USPC 277/300; 277/500

(57) ABSTRACT

A sealing assembly including a sealing component and a structural member. The sealing component has a first surface structure. The structural member has a second surface structure. A portion of the second surface structure is in contact with at least a portion of the first surface structure. The first surface structure and/or the second surface structure is a nano-textured surface. Interaction of the first surface structure with the second surface structure dynamically reduces friction, leakage of a fluid, and/or wear between the sealing component and the structural member.

### CROSS REFERENCE TO RELATED APPLICATIONS

This is a non-provisional application based upon U.S. provisional patent application Ser. No. 61/576,150, entitled “SEALING AND/OR BEARING SYSTEM WITH A MICRO OR NANO PATTERN”, filed Dec. 15, 2011, which is incorporated herein by reference.

### BACKGROUND OF THE INVENTION

1. Field of the Invention

The present invention relates to sealing systems, and, more particularly, to dynamic sealing assemblies.

2. Description of the Related Art

A mechanical seal such as a radial shaft seal, also known as a lip seal, is used to seal rotary elements, such as a shaft rotating relative to a housing. Lip seals include strut seals, hydraulic pump seals, axle seals and power steering seals. Historically these seals may have used materials such as rawhide as the sealing element. Today a vast array of elastomers have replaced rawhide for use in sealing elements.

Seal construction typically includes a sprung main sealing lip which is in contact with the rotary shaft. The contact is typically formed having two angles, an air side angle that is usually less than an oil side (pressurized side) angle. Depending on the type of seal, these two angles are selected to create a pressure distribution along the seal contact. It is said that the seal will run wetter if a shallower slope on the oil side of the seal is provided. Often a spring structure is added to the seal to bias the air and/or the oil side of the seal. A dust or exclusion lip may be included in the seal in order to exclude contaminants to thereby protect the sealing properties.

Another type of seal is a reciprocating seal designed to seal against a dynamic mating surface like a shaft. This assembly incorporates a compressed seal assembly that relies on the energy from compression and the applied fluid pressure to exert force on sealing lips or edges to shear fluid film to a level such that the fluid film is thin enough to not result in a collection that could be called leakage, and thick enough to support limited seal to shaft mating surface contact, such that the majority of the sealing interface is riding on a thin fluid film that provides low friction and wear.

Another type of seal is in the form of an end face mechanical seal that uses both rigid and flexible elements to maintain contact at a sealing interface. Some of the elements slide on each other to thereby allow a rotating element to pass through a sealed case. The elements may be hydraulically and/or mechanically loaded with a spring or other biasing construct.

Hydrodynamic seals make use of a dynamic rotor having grooves that act as a pump and creates a film that the opposing sealing surface will ride on. Generally hydrodynamic seals perform better than hydrostatic seals by providing greater film stiffness, lower leakage and lower lift off speeds. Various configurations of groove designs exist. Problems with these types of seals are that they are typically unidirectional seals for best effectiveness, the hydrodynamic pumping is dependent heavily on having relative rotation, and the effect is often limited to only a select portion of the contact surface, so areas away from the pumping mechanism features often do not see any improvement.

Often seals have to work under pressures and temperatures that are typically, both high at over 15,000 psi and potential temperatures of approximately 400° F. in abrasive atmospheres. Reliability of the sealing system is of paramount concern, because of the cost of downtime in certain operations. Often sealing systems must be able to be sealed in both directions, and prior sealing systems have also required a larger area to accommodate two uni-directional seals in separate grooves in the hardware. This increases the weight and space required, increasing the overall cost of the system, and does not provide the necessary sealing performance for the expected duration due to eventual pressure build-up between the two seals eventually destroying the seals.

Since almost all seals utilize the process liquid or gas to lubricate the seal faces, they are designed to leak. However leakage is a concern particularly as the pressure against the seal may be higher as a shaft turns within the seal.

What is needed in the art is a dynamic sealing assembly that is capable of bi-directional performance and results in reduced wear, friction and/or leakage.

### SUMMARY OF THE INVENTION

The present invention provides a sealing assembly configured to dynamically reduce wear, friction and/or leakage of the seal.

The invention in one form is directed to a sealing assembly including a sealing component and a structural member. The sealing component has a first surface structure. The structural member has a second surface structure. A portion of the second surface structure is in contact with at least a portion of the first surface structure. The first surface structure and/or the second surface structure is a nano-textured surface. Interaction of the first surface structure with the second surface structure dynamically reduces friction, leakage of a fluid, and/or wear between the sealing component and the structural member.

The invention in another form is directed to a method of reducing friction, leakage or wear of a sealing component, the method including two selecting steps and a slidingly mating step. The first selecting step is the selecting of a sealing component with a first surface structure. The second selecting step is the selecting of a structural member with a second surface structure.

The first surface structure and/or the second surface structure being a nano-textured surface. The slidingly mating includes the slidingly mating of the first surface structure with the second surface structure thereby dynamically reducing friction, leakage and/or wear between the sealing component and the structural member.

An advantage of the present invention is that it provides a sealing assembly suitable for bi-directional rotation or linear translation.

Another advantage of the present invention is that it allows for a tailoring of the surface structure to alter the seal performance.

Yet another advantage of the present invention is that it provides a sealing assembly that reduces the leakage using a pumping action that result from the interaction of the nano-textured surface(s).

Yet another advantage of the present invention is that the shape and distribution of the textured surface creates a pressure to separate the surfaces, with the surface structure attracting the fluids to stay with the surface, and to resist the shearing of the fluid film.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of a structural member in the form of a shaft having an embodiment of a nano-textured surface according to the present invention;

FIG. 2 is a perspective view of a sealing component having a surface structure that may be in the form of a nano-textured surface according to the present invention;

FIG. 3 is a sectional view of yet another embodiment of a sealing assembly according to the present invention;

FIG. 4 is a perspective view of yet another embodiment of a sealing component having a surface structure according to the present invention;

FIG. 5 is a cross-sectional view of a portion of the shaft of FIG. 1 and a sealing component;

FIG. 6 is a perspective view of yet another embodiment of a sealing component having a surface structure according to the present invention;

FIG. 7 is a schematical representation of a nano-textured surface used on a structural member, such as the shaft of FIGS. 1 and 5, and/or the sealing components of FIGS. 2-6 and 8 according to the present invention; and

FIG. 8 is a perspective view of yet another embodiment of a sealing component having a surface structure according to the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

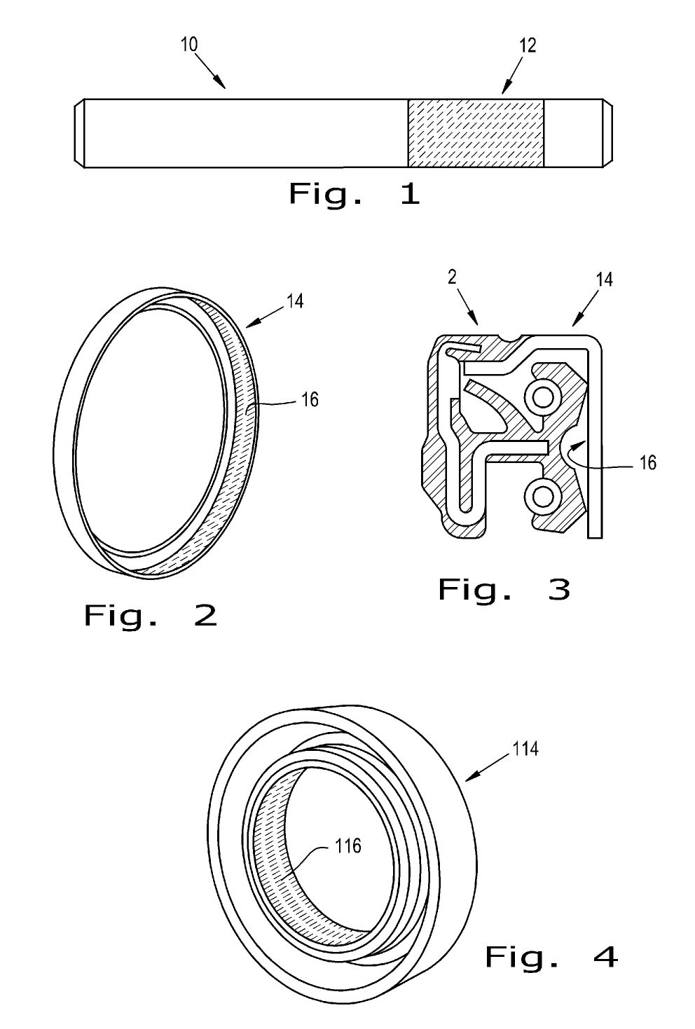

Referring now to the drawings there is shown an embodiment of a sealing assembly of the present invention with nano patterns on the surfaces of seals and bearings. Now, referring to FIG. 1 there is illustrated a cylindrical shaft or rod 10 with a surface structure 12 in the form of a nano-textured surface 12. Now, additionally referring to FIG. 2 there is illustrated a seal 14 having surface structure 16 in the form of a nano-textured surface 16, with a cross-sectional view of a seal assembly 2 shown in FIG. 3, with nano-textured surface 16 of seal 14 in contact with other portions of seal assembly 2.

Now, additionally referring to FIG. 4 there is shown a seal 114 with a surface structure 116. The numbers used herein, with some multiple of 100 added thereto, is to denote a similarity with other parts having the same two least significant digits. Reference numbers herein relative to a specific structure or property should be broadly understood to apply to other structures herein having the same least significant digits.

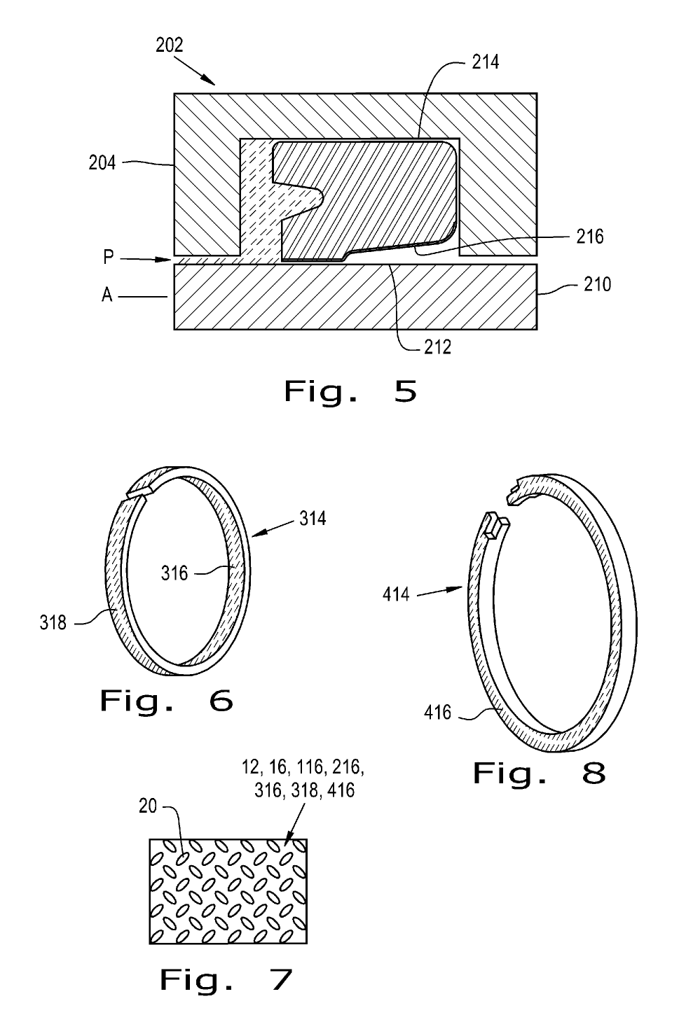

Now, additionally referring to FIG. 5 there is illustrated a sealing assembly 202 with a seal retainer 204 having a seal 214 in contact with a shaft 210. Seal 214 has a surface structure 216 that interacts with surface structure 212 of shaft 210. Now, additionally referring to FIG. 6 there is illustrated a split seal 314 having a surface structure 316 on one side and a surface structure 318 on an opposite side. This illustrates that multiple surface structures can be applied to achieve different sealing goals.

Now, additionally referring to FIG. 7, there is schematically illustrated nano-textured surface 12, 16, 116, 216, 316, 318 and 416. This nano-textured surface has features that are selectively placed on surfaces of seals 14, and on reciprocating or rotating elements such as those illustrated herein such as shaft 10 and 210. The pattern of asperities 20 may be repetitive and at least partially symmetrical as shown in FIGS. 1 and 7, or progressive in size, pattern frequency, and/or asymmetrical in nature. The nano-textured surface provides a reduced friction, improved wear characteristics, and/or sealing performance. These nano-textures control the fluid film adjacent to the seal or bearing surface to achieve the reduced friction, decreased wear and/or improved sealing. The improved performance may be necessary only on a portion of the surface and for only a portion of a duty cycle, so they can be selectively placed along a shaft 10.

Now, additionally referring to FIG. 8, there is shown a seal or ring 414 having a nano-textured surface 416 on a face of one side thereof. Other configurations of seals are also contemplated having nano-textured surfaces. For example seal 14 may be a component of a seal assembly 2, and seal 14 may be a rigid or semi-rigid having nano-textured surface 16 on an inside surface that is in contact with a sealing component.

As seen in FIG. 5 a pressurized fluid P exerts pressure on ring 214 with surface structure 216 being applied to a portion of ring 214 enhancing the sealing and frictional performance of ring 214 as structure 204 and shaft 210 move relative to each other. In this embodiment, seal 214 is stationary relative to structure 204, and shaft 210 is rotating about an axis A. Alternatively, shaft 210 may be considered a structural member 210 and the cross-section shown may be a portion of another assembly or a part of a sealing assembly 202. Still further, structural member 210 may move in a linear fashion relative to sealing component 214.

As structural member 210 moves relative to sealing component 214, the interaction of either or both surface structures 212 and 216 coact to cause a pumping action, or a fluid bias, to occur that is exerted in a direction opposite to the direction in which the arrow extends from P. The bias on the fluid serves to reduce the leakage of fluid from the pressurized side of sealing component 214. While one of surface structures 212 and 216 may be smooth, the other would be a nano-textured surface. The interaction of surfaces 212 and 216 reduce friction, wear and/or leakage.

The nano-textured surface, applied to the surface of either the seal or bearing surface and/or to a dynamic surface is schematically illustrated herein, includes the application of textures to polymer/metal bearings, cassettes or cans with dynamic sealing surfaces. The nano-textured surface structure may be molded, formed or be an otherwise created structure on curved or flat metal, polymer, or ceramic surfaces, using forming techniques such as those pioneered by Hoowaki. The use of the word dynamic or dynamically refers to a movement between shaft 210 and seal 214.

The nano-textured surface may be in the form of a pattern as shown in FIG. 7. The pattern of asperities 20 being repetitive and symmetrical. The pattern may be interleaved, meaning that different orientations of a shape can be repeated, as shown in FIG. 7, where quasi-oval shapes are oriented in two different directions in an interleaving manner. It is also contemplated that the patterns can include elements 20 or asperities 20 that are progressive in size or that they are arranged in an asymmetrical manner. The asperities 20 within the pattern are pillars and/or depressions also referred to as dimples, with asperities 20 having a geometrical shape, as viewed normal to the nano-textured surface, that is, among other shapes, circular, oval, square, rectangular, trapezoidal, hexagonal, star-shaped, chevron, and/or triangular in nature, even a combination of shapes is contemplated within a pattern.

The spacing of the asperities may be uniform or non-uniform in nature to accomplish a specific performance criteria by way of the selection of the materials that structural member 10 and seal 14 are made of as well as the location of the nano-textured surface, the pattern of the nano-textured surface, and the size and type of asperity (pillars or depressions). For example, nano-textured surface 12 may be a triangular lattice of depressions 35,000 nm deep, 120,000 nm wide, circular in nature and spaced 50,000 nm spaced apart was placed on a shaft 10 and used in conjunction with a seal 14 having a smooth surface in contact with shaft 10. This selected combination of patterns results in reduced rotational friction.

The selection of the asperity shape and distribution provide for the creation of a pressure to separate the surfaces, and to attract the fluids to stay with the nano-textured surface, and to resist the normal condition of the shearing of the fluid film that reduces the distance between the two moving surfaces. It is contemplated that the defined shapes are symmetrical allowing bi-directional benefits of the sealing assembly, unlike the prior art. The sizes of the asperities may be as small as 1 nm, in the range of 1-10 nm, 1-100 nm, 1-1,000 nm or even the size discussed above.

In sealing assembly 202 the interaction between surface 212 and surface 216 causes fluid adjacent to the nano-textured surface to have a thicker fluid film between surfaces 212 and 216 than it would otherwise display. Additionally the fluid film therebetween is of a more consistent height under a wider range of pressures, speeds and temperatures at the interface between surfaces 212 and 216.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sealing assembly, comprising:
a sealing component having a first surface structure; and
a structural member having a second surface structure, a portion of said second surface structure being in contact with at least a portion of said first surface structure, at least one of said first surface structure and said second surface structure being a nano-textured surface, interaction of said first surface structure with said second surface structure dynamically reducing at least one of friction, leakage of a fluid, and wear between said sealing component and said structural member.

2. The sealing assembly of claim 1, wherein said nano-textured surface is in the form of a pattern.

3. The sealing assembly of claim 2, wherein said pattern is repetitive.

4. The sealing assembly of claim 3, wherein said pattern is also symmetrical.

5. The sealing assembly of claim 2, wherein said pattern is progressive in size.

6. The sealing assembly of claim 2, wherein said pattern is asymmetrical.

7. The sealing assembly of claim 2, wherein said nano-textured surface is at least one of pillars and depressions.

8. The sealing assembly of claim 1, wherein said nano-textured surface alters a flow of said fluid adjacent to said nano-textured surface thereby increasing fluidic sealing between said first surface structure and said second surface structure.

9. The sealing assembly of claim 8, wherein said increased fluidic sealing is dependent upon an interaction between said first surface and said second surface causing fluid adjacent to said nano-textured surface to be one of increased and consistent thickness.

10. The sealing assembly of claim 9, wherein said interaction includes a movement of said first surface structure relative to said second surface structure.

11. The sealing assembly of claim 10, wherein said movement is one of a linear movement and a rotational movement, said one of increased and consistent thickness occurring regardless of a direction of rotational movement.

12. The sealing assembly of claim 1, wherein said nano-textured surface includes a plurality of at least one of pillars and dimples arranged in a pattern.

13. The sealing assembly of claim 12, wherein said pillars and dimples have a shape viewed normal to said nano-textured surface, said shape being one of circular, oval, square, rectangular, trapezoidal, hexagonal, star-shaped, chevron and triangular.

14. The sealing assembly of claim 13, wherein said shapes are interleaved.

15. A method of reducing friction, leakage or wear of a sealing component, the method comprising the steps of:
selecting a sealing component with a first surface structure selecting a structural member with a second surface structure, at least one of said first surface structure and said second surface structure being a nano-textured surface; and
slidingly mating said first surface structure with said second surface structure thereby dynamically reducing at least one of friction, leakage and wear between said sealing component and said structural member.

16. The method of claim 15, wherein said slidingly mate step includes the steps of rotating said structural member relative to said sealing component and interacting said first surface structure and said second surface structure to cause said fluid adjacent to said nano-textured surface causing fluid adjacent to said nano-textured surface to be of one of increased and consistent thickness.

17. The method of claim 16, wherein said nano-textured surface includes a plurality of at least one of pillars and dimples arranged in a pattern.

18. The method of claim 17, wherein said pillars and dimples have a shape viewed normal to said nano-textured surface, said shape being one of circular, oval, square, rectangular, trapezoidal, hexagonal, star-shaped, chevron and triangular.

19. The method of claim 18, wherein said shapes are interleaved.

20. The method of claim 19, wherein said pattern is asymmetrical.
